(19) United States
(12) Patent Application Publication
(10) Pub. No.: US 2026/0038532 A1
(43) Pub. Date: Feb. 5, 2026

(54) MEDIA EDITING IN AN ENVIRONMENT

(71) Applicant: Apple Inc., Cupertino, CA (US)

(72) Inventor: Vivaan BAHL, Palo Alto, CA (US)

(21) Appl. No.: 19/285,593

(22) Filed: Jul. 30, 2025

Related U.S. Application Data
(60) Provisional application No. 63/679,053, filed on Aug. 2, 2024.

(51) Int. Cl. G11B 27/34

(52) U.S. Cl. CPC G11B 27/34

(57) ABSTRACT

An electronic device displays a media editing environment including features for creating, editing, and displaying alternative timelines (e.g., alternative storylines) that branch from a primary timeline (e.g., a main storyline) of a media project. An electronic device detects and responds to input corresponding to selection of an alternative timeline during a runtime of a media project.

### CROSS REFERENCE TO RELATED APPLICATIONS

This application claims the benefit of U.S. Provisional Application No. 63/679,053, filed Aug. 2, 2024, the entire disclosure of which is herein incorporated by reference for all purposes.

### FIELD OF THE DISCLOSURE

This relates generally to systems and methods involving media editing applications, user interfaces, and environments and involving presentation of media.

### BACKGROUND OF THE DISCLOSURE

Some computer graphical environments provide environments for creating or editing media projects, such as media projects including audio clips and/or video clips.

### SUMMARY OF THE DISCLOSURE

A media creator can use a media editing application to edit and create a media project. A media project has a timeline, which is optionally a series or sequence of clips (e.g., audio and/or video clips) that comprises the media project. In some cases, a media editing application shows a timeline where clips can be added, arranged, and/or edited. Further, a timeline (e.g., a primary timeline) is optionally associated with a sequence of clips, which comprise a storyline, such as a primary timeline being associated with a primary storyline (e.g., a main sequence of clips). Some aspects of the disclosure involve a media editor environment (e.g., a two-dimensional or three-dimensional media editor environment) allowing branching of a timeline of a media project into alternative timelines (e.g., different storylines) at one or more time positions of the timeline of the media project such that playback of the media project would involve presentation of different clips and/or different sequences of clips in accordance with selection of different storylines at the one or more time positions of the timeline.

Some aspects of the disclosure include displaying a timeline that includes user interface elements for receiving representations (e.g., two-dimensional or three-dimensional representations) of media clips (e.g., audio and/or video clips). For example, the user interface elements optionally include a user interface element for receiving representations of audio clips and include a user interface element for receiving representations of video clips.

Some aspects of the disclosure include detecting and responding to inputs to receive, edit, arrange, or otherwise modify clips in a timeline. For example, an electronic device can detect and respond to input for adjusting a clip length (e.g., number of frames included in the clip, adjusting a range of the clip) by adjusting one or more dimensions of the two-dimensional or three-dimensional representations of the clip in accordance with the input, thus confirming that the clip is adjusted. As another example, an electronic device can detect and respond to input for re-arranging clips in a timeline by re-arranging the representations of clips in the timeline in accordance with the input.

Some aspects of the disclosure include displaying a media editing environment including features for creating, editing, and displaying alternative timelines (e.g., alternative storylines) of a media project. For example, a media creator may desire to create a media project that includes a primary storyline (e.g., a main sequence of clips of content of the media project in a timeline) and one or more alternative storylines (e.g., one or more alternative timelines, such as one or more alternative sequences of clips of the media project) at one or more time positions branching from the primary storyline. The electronic device can detect and respond to input for creating and/or displaying the one or more alternative timelines. For example, while displaying a first timeline (e.g., a primary timeline) in a media editing environment, the electronic device can detect an input for creating one or more alternative timelines in the media project. In response, the electronic device optionally displays a timeline branching user interface element that, at a time position in first timeline, branches the first timeline into a plurality of timelines. The one or more alternative timelines may each include user interface elements for receiving representations (e.g., two-dimensional or three-dimensional representations) of media clips (e.g., audio and/or video clips) into the respective alternative timeline. For example, the user interface elements optionally include a user interface element for receiving representations of audio clips into the respective alternative timeline and include a user interface element for receiving representations of video clips into the respective alternative timeline. In some examples, in response to input for creating the one or more alternative timelines, the electronic device displays a media clip user interface for defining portions of media as selectable to display alternative timelines during a runtime of the media project (e.g., to allow the user to choose a timeline of plurality of timelines during the runtime of the media project). In some examples, the electronic device can display a timeline coalescing user interface element for coalescing the plurality of alternative timelines that branch from the timeline branching user interface element. In some examples, a timeline of a media project includes a first portion and a second portion, and the electronic device selectively displays the first portion or the second portion at a first size, without displaying both the first portion and the second portion at the first size or without displaying the second portion.

Some aspects of the disclosure include an electronic device detecting and responding to input corresponding to selection of an alternative timeline during a runtime of a media project. In some examples, the input includes a gaze of the user directed to a respective portion of the media content of a primary timeline, and in response to the electronic device detecting the input, in accordance with a determination that respective portion of the media content is a first portion, the electronic device displays a first alternative timeline (e.g., a first alternative storyline) of the media project, and in accordance with a determination that the respective portion of the media content is a second portion, different from the first portion, the electronic device display a second alternative timeline (e.g., a second alternative storyline) of the media project, different from the first timeline (e.g., the first alternative storyline) of the media project. In some examples, a playback state of the media project is maintained during the detection and response to the input. For example, when the input is detected, the media project is optionally playing, and in response to detecting the input, the media project is still playing. As such, in some examples, the electronic device detects and responds to input corresponding to selection of an alternative timeline during a runtime of a media project without pausing of the media project.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIG. 2 illustrates a block diagram of an example architecture for a system according to some examples of the disclosure.

FIG. 3 illustrates an example schematic of a primary timeline of a media project that branches into multiple timelines according to some examples of the disclosure.

FIG. 4 illustrates an example of an electronic device displaying a representation of a clip and a media clip user interface according to some examples of the disclosure.

FIG. 5 illustrates an example of an electronic device displaying a primary timeline according to some examples of the disclosure.

FIG. 6 illustrates an example of an electronic device displaying a video editing user interface for adjusting clip attributes according to some examples of the disclosure.

FIG. 7 illustrates an example of an electronic device displaying a timeline branching user interface element in a primary timeline of a media project and displaying a media clip user interface for defining portions of media in the primary timeline as selectable to display alternative timelines during a runtime of the media project according to some examples of the disclosure.

FIGS. 8 and 9 illustrate examples of an electronic device displaying the media clip user interface of FIG. 7 and detecting and responding to inputs for defining portions of media in the primary timeline as selectable to display alternative timelines during a runtime of the media project according to some examples of the disclosure.

FIG. 10 illustrates alternative examples of timeline selection during a runtime of a media project according to some examples of the disclosure.

FIG. 11 illustrates an electronic device displaying alternative timelines of different lengths according to some examples of the disclosure.

FIGS. 12 and 13 illustrate examples of an electronic device displaying primary timeline with different amounts of alternative timelines that branch from the primary timeline according to some examples of the disclosure.

FIG. 14 illustrates examples of electronic devices displaying a map of a timeline according to some examples of the disclosure.

FIGS. 15 and 16 illustrate an example of an electronic device detecting and responding to input for moving a current playback position indicator in a timeline according to some examples of the disclosure.

FIG. 17 is a flow diagram illustrating a method for adding a timeline branching user interface element for branching a first timeline into a plurality of timelines according to some examples of the disclosure.

### DETAILED DESCRIPTION

A media creator can use a media editing application to edit and create a media project. A media project has a timeline, which is optionally a series or sequence of clips (e.g., audio and/or video clips) that comprises the media project. In some cases, a media editing application shows a timeline where clips can be added, arranged, and/or edited. Further, a timeline (e.g., a primary timeline) is optionally associated with a sequence of clips, which comprise a storyline, such as a primary timeline being associated with a primary storyline (e.g., a main sequence of clips). Some aspects of the disclosure involve a media editor environment (e.g., a two-dimensional or three-dimensional media editor environment) allowing branching of a timeline of a media project into alternative timelines (e.g., different storylines) at one or more time positions of the timeline of the media project such that playback of the media project would involve presentation of different clips and/or different sequences of clips in accordance with selection of different storylines at the one or more time positions of the timeline.

Some aspects of the disclosure include displaying a timeline that includes user interface elements for receiving representations (e.g., two-dimensional or three-dimensional representations) of media clips (e.g., audio and/or video clips). For example, the user interface elements optionally include a user interface element for receiving representations of audio clips and include a user interface element for receiving representations of video clips.

Some aspects of the disclosure include detecting and responding to inputs to receive, edit, arrange, or otherwise modify clips in a timeline. For example, an electronic device can detect and respond to input for adjusting a clip length (e.g., number of frames included in the clip, adjusting a range of the clip) by adjusting one or more dimensions of the two-dimensional or three-dimensional representations of the clip in accordance with the input, thus confirming that the clip is adjusted. As another example, an electronic device can detect and respond to input for re-arranging clips in a timeline by re-arranging the representations of clips in the timeline in accordance with the input.

Some aspects of the disclosure include displaying a media editing environment including features for creating, editing, and displaying alternative timelines (e.g., alternative storylines) of a media project. For example, a media creator may desire to create a media project that includes a primary storyline (e.g., a main sequence of clips of content of the media project in a timeline) and one or more alternative storylines (e.g., one or more alternative timelines, such as one or more alternative sequences of clips of the media project) at one or more time positions branching from the primary storyline. The electronic device can detect and respond to input for creating and/or displaying the one or more alternative timelines. For example, while displaying a first timeline (e.g., a primary timeline) in a media editing environment, the electronic device can detect an input for creating one or more alternative timelines in the media project. In response, the electronic device optionally displays a timeline branching user interface element that, at a time position in first timeline, branches the first timeline into a plurality of timelines. The one or more alternative timelines may each include user interface elements for receiving representations (e.g., two-dimensional or three-dimensional representations) of media clips (e.g., audio and/or video clips) into the respective alternative timeline. For example, the user interface elements optionally include a user interface element for receiving representations of audio clips into the respective alternative timeline and include a user interface element for receiving representations of video clips into the respective alternative timeline. In some examples, in response to input for creating the one or more alternative timelines, the electronic device displays a media clip user interface for defining portions of media as selectable to display alternative timelines during a runtime of the media project (e.g., to allow the user to choose a timeline of plurality of timelines during the runtime of the media project). In some examples, the electronic device can display a timeline coalescing user interface element for coalescing the plurality of alternative timelines that branch from the timeline branching user interface element. In some examples, a timeline of a media project includes a first portion and a second portion, and the electronic device selectively displays the first portion or the second portion at a first size, without displaying both the first portion and the second portion at the first size or without displaying the second portion.

Some aspects of the disclosure include an electronic device detecting and responding to input corresponding to selection of an alternative timeline during a runtime of a media project. In some examples, the input includes a gaze of the user directed to a respective portion of the media content of a primary timeline, and in response to the electronic device detecting the input, in accordance with a determination that respective portion of the media content is a first portion, the electronic device displays a first alternative timeline (e.g., a first alternative storyline) of the media project, and in accordance with a determination that the respective portion of the media content is a second portion, different from the first portion, the electronic device display a second alternative timeline (e.g., a second alternative storyline) of the media project, different from the first timeline (e.g., the first alternative storyline) of the media project. In some examples, a playback state of the media project is maintained during the detection and response to the input. For example, when the input is detected, the media project is optionally playing, and in response to detecting the input, the media project is still playing. As such, in some examples, the electronic device detects and responds to input corresponding to selection of an alternative timeline during a runtime of a media project without pausing of the media project.

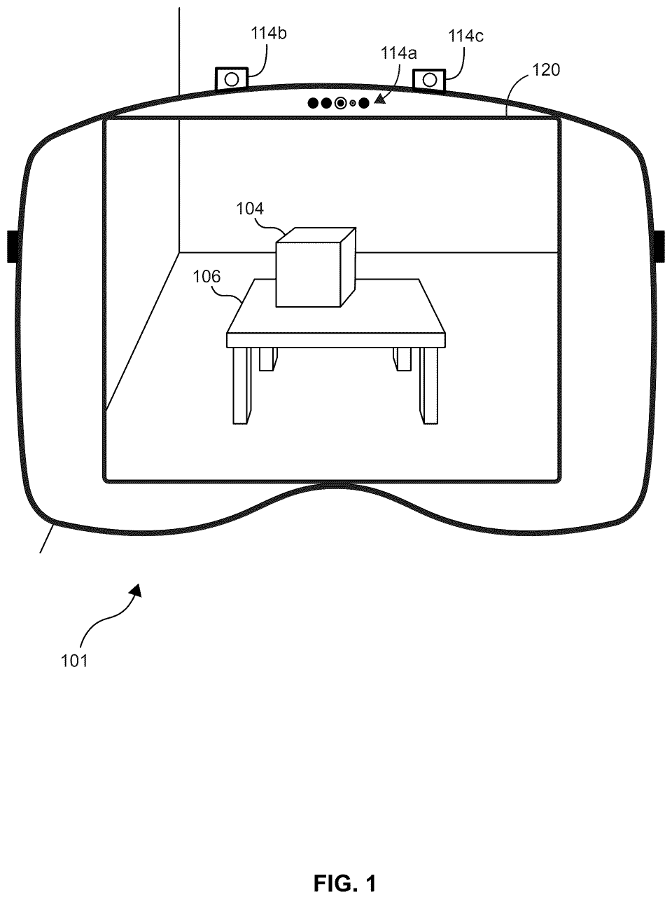

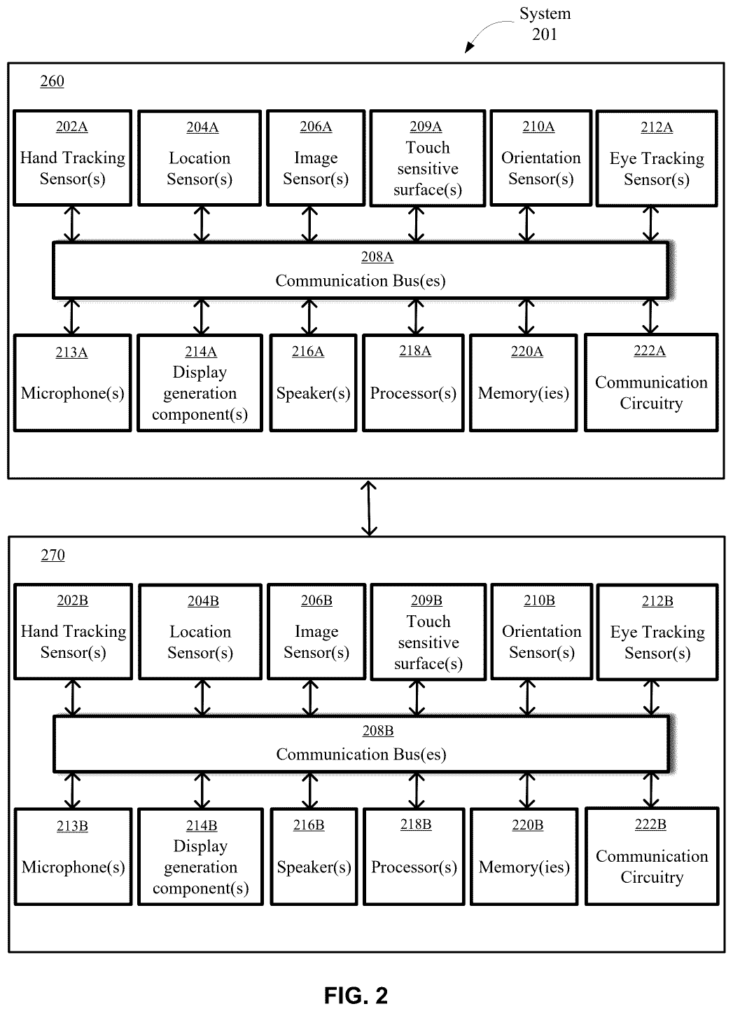

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c. While a single display 120 is shown, it should be appreciated that display 120 may include a stereo pair of displays.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component (e.g., one or more displays) and one or more input devices is described. Further, the electronic device is optionally in communication with one or more output devices such as one or more audio output devices. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a media editing application such as a linear or nonlinear media editing application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for a system 201 according to some examples of the disclosure. In some examples, system 201 includes multiple devices. For example, the system 201 includes a first electronic device 260 and a second electronic device 270, wherein the first electronic device 260 and the second electronic device 270 are in communication with each other. In some examples, the first electronic device 260 and the second electronic device 270 are a portable device, such as a mobile phone, smart phone, a tablet computer, a laptop computer, an auxiliary device in communication with another device, a head-mounted display, etc., respectively. For example, first electronic device 260 is optionally a head-mounted display device and second electronic device 270 is optionally a laptop computer that performs one or more processing operations. For example, first electronic device 260 may offload compute one or more processing operations to the second electronic device 270. In some examples, the first electronic device 260 and the second electronic device 270 correspond to electronic device 101 described above with reference to FIG. 1. As another example, first electronic device 260 is optionally a head-mounted display device and second electronic device 270 is optionally a desktop computer (or another type of computer) that performs one or more processing operations. For example, first electronic device 260 may offload compute one or more processing operations to the second electronic device 270.

As illustrated in FIG. 2, the first electronic device 260 optionally includes various sensors (e.g., one or more hand tracking sensors 202A, one or more location sensors 204A, one or more image sensors 206A, one or more touch-sensitive surfaces 209A, one or more motion and/or orientation sensors 210A, one or more eye tracking sensors 212A, one or more microphones 213A or other audio sensors, one or more body tracking sensors (e.g., torso and/or head tracking sensors), one or more display generation components 214A, one or more speakers 216A, one or more processors 218A, one or more memories 220A, and/or communication circuitry 222A. In some examples, the second device 270 optionally includes various sensors (e.g., one or more hand tracking sensors 202B, one or more location sensors 204B, one or more image sensors 206B, one or more touch-sensitive surfaces 209B, one or more motion and/or orientation sensors 210B, one or more eye tracking sensors 212B, one or more microphones 213B or other audio sensors, one or more body tracking sensors (e.g., torso and/or head tracking sensors), one or more display generation components 214B, one or more speakers 216, one or more processors 218B, one or more memories 220B, and/or communication circuitry 222B. In some examples, the one or more display generation components 214A, 214B correspond to display 120 in FIG. 1. One or more communication buses 208A and 208B are optionally used for communication between the above-mentioned components of electronic devices 260 and 270, respectively. First electronic device 260 and second electronic device 270 optionally communicate via a wired or wireless connection (e.g., via communication circuitry 222A, 222B) between the two devices.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®.

Processor(s) 218A, 218B include one or more general processors, one or more graphics processors, and/or one or more digital signal processors. In some examples, memory 220A, 220B is a non-transitory computer-readable storage medium (e.g., flash memory, random access memory, or other volatile or non-volatile memory or storage) that stores computer-readable instructions configured to be executed by processor(s) 218A, 218B to perform the techniques, processes, and/or methods described below. In some examples, memory 220A, 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214A, 214B include a single display (e.g., a liquid-crystal display (LCD), organic light-emitting diode (OLED), or other types of display). In some examples, display generation component(s) 214A, 214B includes multiple displays. In some examples, display generation component(s) 214A, 214B can include a display with touch capability (e.g., a touch screen), a projector, a holographic projector, a retinal projector, a transparent or translucent display, etc. In some examples, electronic devices 260 and 270 include touch-sensitive surface(s) 209A and 209B, respectively, for receiving user inputs, such as tap inputs and swipe inputs or other gestures. In some examples, display generation component(s) 214A, 214B and touch-sensitive surface(s) 209A, 209B form touch-sensitive display(s) (e.g., a touch screen integrated with electronic devices 260 and 270, respectively, or external to electronic devices 260 and 270, respectively, that is in communication with electronic devices 260 and 270).

Electronic devices 260 and 270 optionally include image sensor(s) 206A and 206B, respectively. Image sensors(s) 206A/206B optionally include one or more visible light image sensors, such as charged coupled device (CCD) sensors, and/or complementary metal-oxide-semiconductor (CMOS) sensors operable to obtain images of physical objects from the real-world environment. Image sensor(s) 206A/206B also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206A/206B also optionally include one or more cameras configured to capture movement of physical objects in the real-world environment. Image sensor(s) 206A/206B also optionally include one or more depth sensors configured to detect the distance of physical objects from electronic device 260/270. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic devices 260 and 270 use CCD sensors, event cameras, and depth sensors in combination to detect the physical environment around electronic devices 260 and 270. In some examples, image sensor(s) 206A/206B include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 260/270 uses image sensor(s) 206A/206B to detect the position and orientation of electronic device 260/270 and/or display generation component(s) 214A/214B in the real-world environment. For example, electronic device 260/270 uses image sensor(s) 206A/206B to track the position and orientation of display generation component(s) 214A/214B relative to one or more fixed objects in the real-world environment.

In some examples, electronic device 260/270 includes microphone(s) 213A/213B or other audio sensors. Device 260/270 uses microphone(s) 213A/213B to detect sound from the user and/or the real-world environment of the user. In some examples, microphone(s) 213A/213B includes an array of microphones (a plurality of microphones) that optionally operate in tandem, such as to identify ambient noise or to locate the source of sound in space of the real-world environment.

In some examples, device 260/270 includes location sensor(s) 204A/204B for detecting a location of device 260/270 and/or display generation component(s) 214A/214B. For example, location sensor(s) 204A/204B can include a global positioning system (GPS) receiver that receives data from one or more satellites and allows electronic device 260/270 to determine the device's absolute position in the physical world.

In some examples, electronic device 260/270 includes orientation sensor(s) 210A/210B for detecting orientation and/or movement of electronic device 260/270 and/or display generation component(s) 214A/214B. For example, electronic device 260/270 uses orientation sensor(s) 210A/210B to track changes in the position and/or orientation of electronic device 260/270 and/or display generation component(s) 214A/214B, such as with respect to physical objects in the real-world environment. Orientation sensor(s) 210A/210B optionally include one or more gyroscopes and/or one or more accelerometers.

Electronic device 260/270 includes hand tracking sensor(s) 202A/202B and/or eye tracking sensor(s) 212A/212B (and/or other body tracking sensor(s), such as leg, torso, and/or head tracking sensor(s)), in some examples. Hand tracking sensor(s) 202A/202B are configured to track the position/location of one or more portions of the user's hands, and/or motions of one or more portions of the user's hands with respect to the extended reality environment, relative to the display generation component(s) 214A/214B, and/or relative to another defined coordinate system. Eye tracking sensor(s) 212A/212B are configured to track the position and movement of a user's gaze (eyes, face, or head, more generally) with respect to the real-world or extended reality environment and/or relative to the display generation component(s) 214A/214B. In some examples, hand tracking sensor(s) 202A/202B and/or eye tracking sensor(s) 212A/212B are implemented together with the display generation component(s) 214A/214B. In some examples, the hand tracking sensor(s) 202A/202B and/or eye tracking sensor(s) 212A/212B are implemented separate from the display generation component(s) 214A/214B.

In some examples, the hand tracking sensor(s) 202A/202B (and/or other body tracking sensor(s), such as leg, torso, and/or head tracking sensor(s)) can use image sensor(s) 206A/206B (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, one or more image sensors 206A/206B are positioned relative to the user to define a field of view of the image sensor(s) 206A/206B and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212A/212B includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 260/270 and system 201 are not limited to the components and configuration of FIG. 2, but can include fewer, other, or additional components in multiple configurations. In some examples, system 201 can be implemented in a single device. In some examples, system 201 is implemented in multiple devices. A person or persons using system 201, is optionally referred to herein as a user or users of the device(s).

In some examples, electronic device 260 displays the media editor environment. In some examples, electronic device 270 the media editor environment. In some examples, electronic device 260 displays the media editor environment and electronic device 270 displays a composed media project that was composed via the media editor environment described herein.

Attention is now directed towards an electronic device displaying a media editing environment including features for creating, editing and displaying alternative timelines of a media project according to some examples of the disclosure.

As described above, some aspects of the disclosure include displaying a media editing environment including features for creating, editing, and displaying alternative timelines (e.g., alternative storylines) of a media project. For example, a media creator may desire to create a media project that includes a primary storyline (e.g., a main sequence of clips of content of the media project in a timeline) and one or more alternative storylines (e.g., one or more alternative timelines, such as one or more alternative sequences of clips of the media project) at one or more time positions branching from the primary storyline. The electronic device can detect and respond to input for creating and/or displaying the one or more alternative timelines. For example, while displaying a first timeline (e.g., a primary timeline) in a media editing environment, the electronic device can detect an input for creating one or more alternative timelines in the media project. In response, the electronic device optionally displays a timeline branching user interface element that, at a time position in first timeline, branches the first timeline into a plurality of timelines. The one or more alternative timelines may each include user interface elements for receiving representations (e.g., three-dimensional representations) of media clips (e.g., audio and/or video clips) into the respective alternative timeline. For example, the user interface elements optionally include a user interface element for receiving representations of audio clips into the respective alternative timeline and include a user interface element for receiving representations of video clips into the respective alternative timeline. In some examples, in response to input for creating the one or more alternative timelines, the electronic device displays a media clip user interface for defining portions of media as selectable to display alternative timelines during a runtime of the media project. In some examples, the electronic device can display a timeline coalescing user interface element for coalescing the plurality of alternative timelines that branch from the timeline branching user interface element. In some examples, the electronic device displays a timeline coalescing user interface element for coalescing the plurality of alternative timelines that branch from the timeline branching user interface element. In some examples, the electronic device smartly displays portions of a media project during editing of the media project to conserve computing resources directed to the media editing application that hosts the media editing environment.

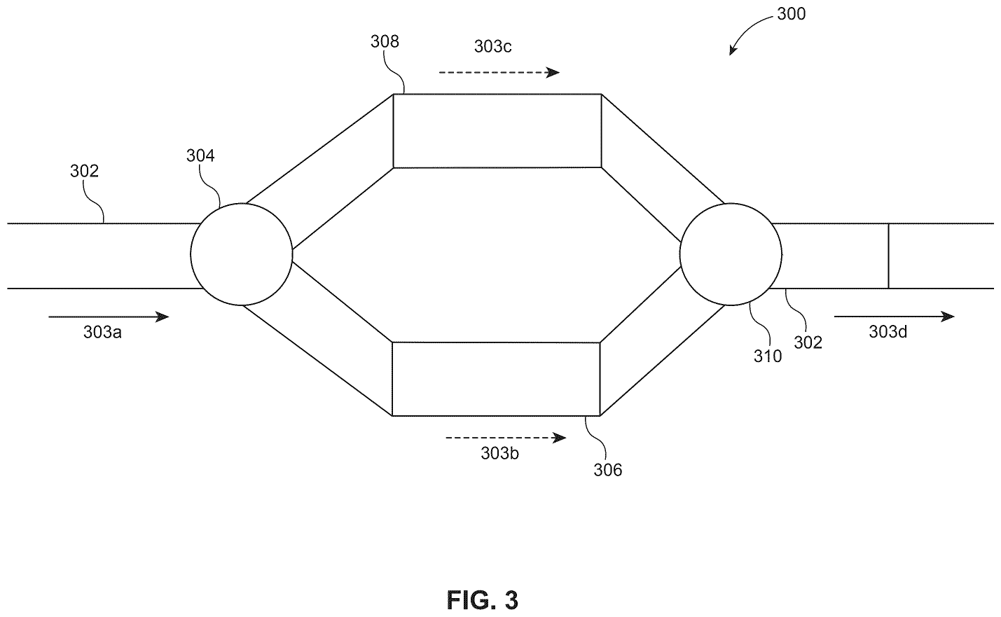

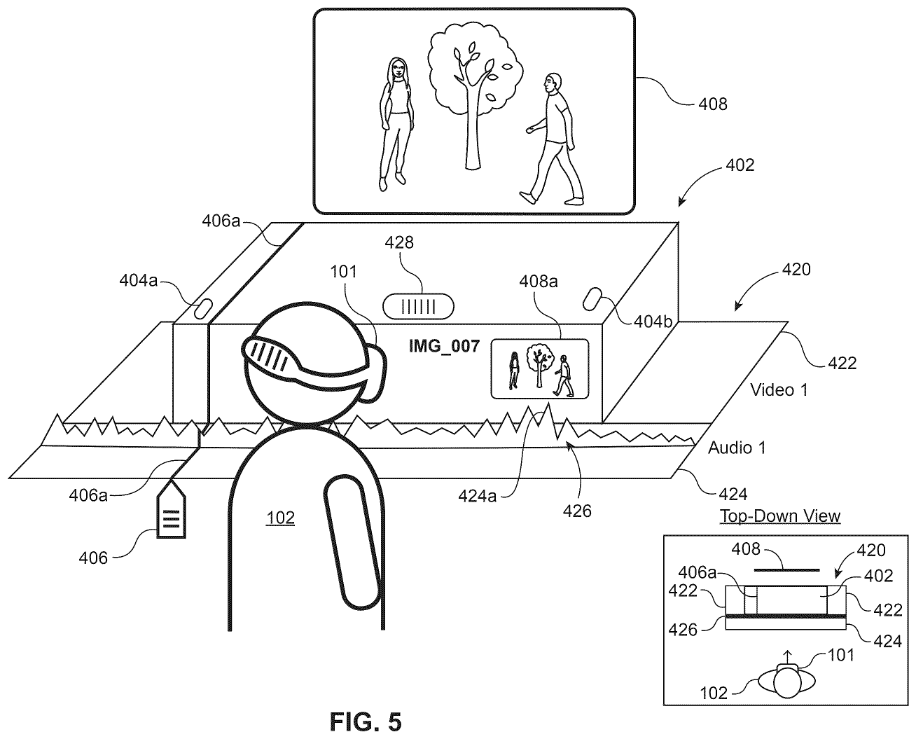

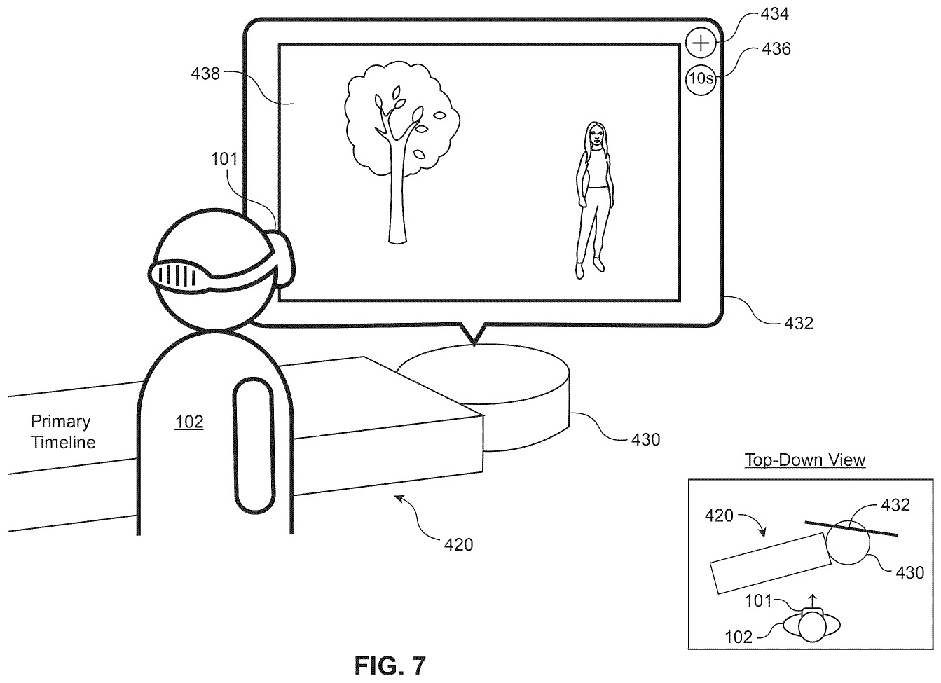

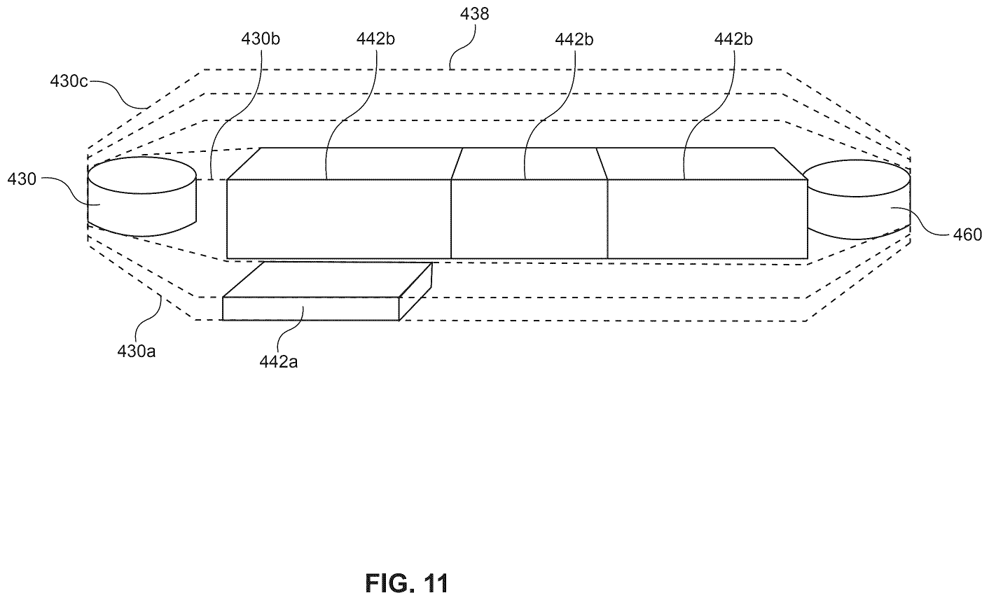

FIG. 3 illustrates an example schematic of a primary timeline of a media project that branches into multiple timelines according to some examples of the disclosure. A timeline includes a plurality of time positions and includes clips (e.g., one or more audio and/or video clips) at different time positions within the timeline. In FIG. 3, timeline 300 includes a primary timeline 302, a timeline branching user interface element 304, alternative timelines 306/308 (e.g., branching timelines), and a timeline coalescing user interface element 310. Timeline branching user interface element 304 branches primary timeline 302 into alternative timelines 306/308, providing for different clips to be inserted and/or arrange into the respective alternative timelines 306/308. Clips can be added, arranged, and/or edited in primary timeline 302 and in alternative timelines 306/308. Timeline coalescing user interface element 310 coalesces the alternative timelines 306/308 into primary timeline 302. In some examples, the electronic device 101 displays timeline 300 in a three-dimensional environment. The user interface elements in FIG. 3 are optionally being represented in a media editing environment and are used to create a media project. In an example, during a runtime of the media project, the electronic device 101 would present the primary storyline of primary timeline 302 (e.g., the sequence of clips along arrow 303a), and in response to reaching a time position of primary timeline 302 that corresponds to the timeline branching user interface element 304), the electronic device 101 would present the storyline of alternative timeline 306 (e.g., the sequence of clips along arrow 303b) or of alternative timeline 308 (e.g., the sequence of clips along arrow 303c) optionally in accordance with input requesting selection of alternative timeline 306 or of alternative timeline 308. Continuing with this example, when playback of the media project reaches a time position of primary timeline 302 that corresponds to the timeline coalescing user interface element 310, the electronic device 101 would present the storyline of primary timeline 302 (e.g., the sequence of clips along arrow 303d). Further details regarding functionalities of user interface elements illustrated in FIG. 3 are described further below such as with reference to primary timeline 420 of FIG. 5, timeline branching user interface element 430 of FIG. 7, timeline coalescing user interface element 460 in FIG. 11, first alternative timeline branch 430a in FIG. 11, and second alternative timeline branch 430b in FIG. 11.

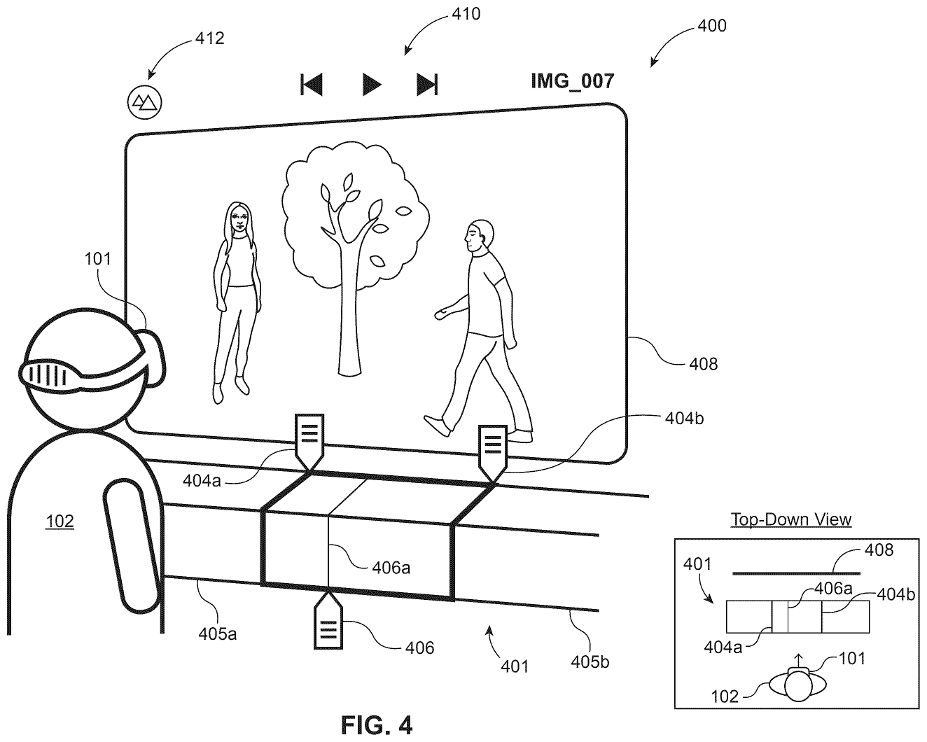

FIG. 4 illustrates an example of an electronic device displaying a representation of a clip and a media clip user interface according to some examples of the disclosure.

In FIG. 4, the electronic device 101 displays media editor environment 400, which in the illustrated example is a three-dimensional environment. The media editor environment 400 corresponds to user interfaces and/or user interface elements of a media editor application for editing and creating media projects. In some examples, the media editor environment 400 is displayed in a virtual environment. For example, the electronic device 101 optionally displays a three-dimensional virtual environment corresponding to a simulated physical location, and while the user is immersed (e.g., fully immersed) in that environment, the electronic device 101 displays the media editor application. In some examples, the media editor environment is displayed while the user is not fully immersed in a virtual environment (e.g., the user is partially immersed in the virtual environment such that one or more portions of the physical environment of the user are visible via display 120 of electronic device 101 or the user is not immersed in a virtual environment such that the environment visible via display 120 of the electronic device includes the media editor environment and the physical environment of the user presented through transparent portions of display 120. As shown in FIG. 4, in some examples, the electronic device 101 displays a user interface element 412 for selecting a virtual environment to display via display 120. In some examples, the electronic device 101 detects and responds to input directed to user interface element 412. For example, in response to input directed to user interface element 412, the electronic device 101 displays a user interface including a platter of user interface elements corresponding to different virtual environments, and in response to detecting input directed to a first user interface element corresponding to a first virtual environment, the electronic device 101 displays the media editor environment in the first virtual environment.

In FIG. 4, the media editor environment 400 includes a clip representation 401 (e.g., a video clip representation) and a media clip user interface 408 that presents (e.g., previews) content of the clip. In FIG. 4, the clip representation 401 optionally corresponds to a video clip, and different positions along the clip representation 401 optionally corresponds to different frames of the video clip. In FIG. 4, a playhead 406 (e.g., playback line) is in the clip representation 401, and the frame being presented (e.g., previewed) in media clip user interface 408 optionally corresponds to the frame that corresponds to that position in the clip representation 401. In FIG. 4, clip representation 401 is trimmed, as indicated by the relative locations of clip start indicator 404a (e.g., start frame indicator, trimmed clip start indicator) and clip end indicator 404b (e.g., end frame indicator, trimmed clip end indicator). These indicators notify of the range of the clip representation 401 (e.g., the range of the frames of the clip) that is currently selected for use (e.g., that is selected for inclusion in a timeline). In FIG. 4, the selected range of the clip representation 401 is trimmed clip representation 401a, which corresponds to a selection of frames of the clip). For instance, the clip representation 401a is optionally representing a 7000 frame clip and trimmed clip representation 401a is optionally representing 2000 frames (e.g., frames 2000-4000 of the 7000 frame clip) and the location of the playhead 406 in FIG. 4 optionally corresponds to frame 2600 of the 7000 frame clip. In FIG. 4, the clip representation 401 also includes clip phantom representations 405a/405b, which correspond to portions of the clip that are outside of the selected range of the clip representation 401 (e.g., outside of the trimmed clip representation 401a). In FIG. 4, the clip is optionally entitled “IMG_007”. In some examples, one or more portions of the clip representation 401 (e.g., the trimmed clip representation 401a) in FIG. 4 is being displayed in a timeline in a media editing environment. In some examples, one or more portions of the clip representation 401 in FIG. 4 is not being displayed in a timeline in a media editing environment.

In some examples, the electronic device 101 detects and responds to input for moving the trimmed clip representation 401a in FIG. 4 into a timeline by moving the trimmed clip representation 401a into the timeline in response to the input. In FIG. 4, the clip representation 401 is optionally three-dimensional. In some examples, clip start indicator 404a and clip end indicator 404b are selectable to adjust a start frame associated with the trimmed clip representation 401a and an end frame associated with the trimmed clip representation 401a. Further, a distance between the clip start indicator 404a and clip end indicator 404b is optionally directly proportional to an amount of frames associated with the trimmed clip representation 401a. In some examples, in FIG. 4, trimmed clip representation 401a is already in a timeline (e.g., a primary timeline). In some examples, in FIG. 4, a timeline (e.g., a primary timeline) is being edited by the user 102.

In FIG. 4, trimmed clip representation 401a is associated with a portion of the frames associated with clip representation 401. For example, clip representation 401 is optionally representing clip of 1800 frames (and/or 1 minute in time length) and the trimmed clip representation 401a is optionally representing 900 frames (and/or 30 seconds in time length) of the clip representation 401. In the illustrated example of FIG. 4, the length of the trimmed clip representation 401a is less than a length of the clip representation 401 because trimmed clip representation 401a is associated with just a portion of the frames associated with clip representation 401.

In FIG. 4, the electronic device 101 displays clip phantom representations 405a/405b to indicate that some frames associated with clip representation 401 have been trimmed off. In some examples, a visual prominence of clip phantom representations 405a/405b is less than a visual prominence of trimmed clip representation 401a. For example, a level of brightness of the clip phantom representations 405a/405b is less than a level of brightness of the trimmed clip representation 401a and/or a degree of transparency of the clip phantom representations 405a/405b is greater than the degree of transparency of the trimmed clip representation 401a.

In some examples, the electronic device 101 detects and responds to input for moving the trimmed clip representation 401a in the three-dimensional environment. For example, in response to detecting user input requesting movement of the trimmed clip representation 401a from a first location to a second location that is different from the first location, the electronic device 101 moves the trimmed clip representation 401a in the three-dimensional environment from the first location to the second location. In some examples, the user input includes movement of a hand of user 102 (optionally while a gaze of the user is directed at the trimmed clip representation 401a) and in response to detecting the user input the electronic device drags the trimmed clip representation 401a in accordance with the movement of the hand of the user 102.

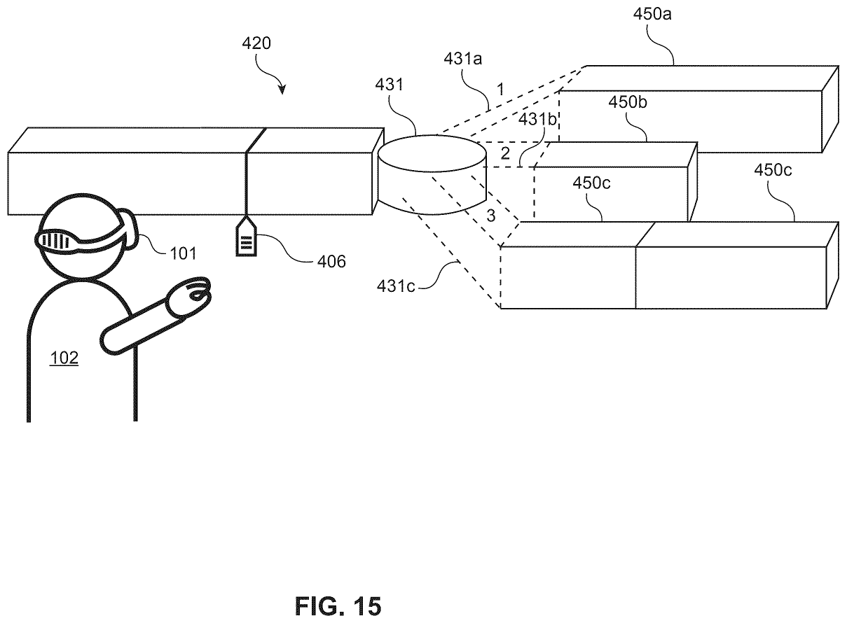

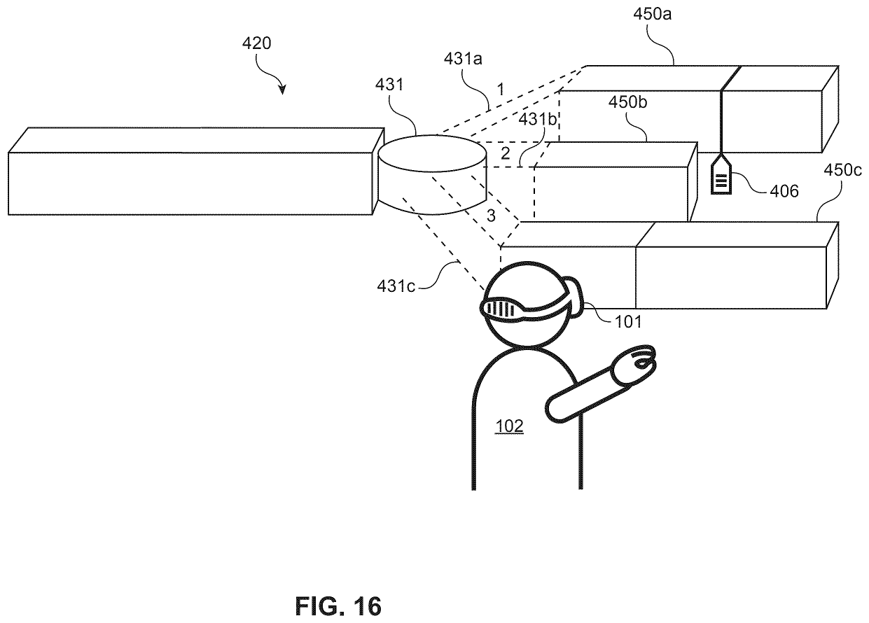

Further, in FIG. 4, electronic device 101 displays playhead 406. In FIG. 4, playhead 406 indicates the current position (e.g., the current time position) in the trimmed clip representation 401a to which the associated frame of the trimmed clip representation 401a in media clip user interface 408 corresponds. In some examples, as shown in FIG. 4, playhead 406 includes playback line 406a that marks the current position in the clip (and/or in a timeline). For example, playhead 406 and playback line 406a move in sync, indicating the current time position (e.g., the current frame position) in the trimmed clip representation 401a to which the media clip user interface 408 corresponds. In some examples, the electronic device 101 detects and responds to input for moving the playhead 406. For example, in response to detecting user input requesting movement of playhead 406 from a first position to a second position, different from the first position, the electronic device 101 optionally moves the playhead 406 and updates display of media clip user interface 408 to show the frame associated with trimmed clip representation 401a at the second position. In some examples, the playhead 406 can be moved from a first timeline to a second timeline. Movement of the playhead 406 in response to input directed to playhead 406 is described further with reference to FIGS. 15 and 16. In some examples, the electronic device 101 moves the playhead 406 moves automatically without detecting user input for moving the playhead 406 during the movement of playhead 406, such as when the playback state of the content of the trimmed clip representation 401a is set to play. In FIG. 4, the electronic device 101 is displaying playback controls 410 (e.g., a rewind control, a pause control, and a fast-forward control) for controlling a playback state of the media in the media clip user interface 408. The playhead 406 optionally moves in accordance with a selected playback control or in accordance with user input directed specifically to the playhead 406.

FIG. 5 illustrates an example of an electronic device displaying a primary timeline 420 according to some examples of the disclosure.

In the illustrated example of FIG. 5, primary timeline 420 includes user interface elements for receiving representations (e.g., three-dimensional representations) of clips. In particular, in FIG. 5, primary timeline 420 includes a first user interface element 422 for receiving video clips (e.g., one or more images) and a second user interface element 424 for receiving audio clips. In the illustrated example of FIG. 5, the electronic device 101 displays a video clip representation 402 in the first user interface element 422 and an audio clip representation 426 of audio clip received into the second user interface element 424. The video clip representation 402 and the audio clip representation 426 are optionally three-dimensional. For example, in FIG. 5, the electronic device 101 displays video clip representation 402 having a first 3D appearance (e.g., shape) and audio clip representation 426 having a second 3D appearance (e.g., shape) different from the first 3D appearance. In some examples, video clip representation 402 in FIG. 5 corresponds to a trimmed clip representation 401a in FIG. 4 in primary timeline 420. In some examples, representations of video clips in primary timeline 420 are of a box or rectangular prism shape, where the width of the box or rectangular prism corresponds to a length of time in the primary timeline 420 that the video clip takes up. Audio clip representation 426 optionally represents one or more selected audio clips (e.g., trimmed audio clips) that are in the primary timeline 420. In FIG. 5, audio clip representation 426 has a shape of a waveform that optionally corresponds to audio amplitude over time for the specific audio clip to which the representation corresponds. For example, in some examples, the electronic device would display in second user interface element 424 differently different audio clips that have different audio amplitude characteristics over time. In some examples, the specificity of the waveform shape optionally enhances frame alignment of the clip(s) to which video clip representation 402 with specific portions the audio clip representation 426. In some examples, a magnitude of the waveform at a particular point of audio clip representation 426 corresponds to a magnitude of volume relative to another point of audio clip representation 426.

In some examples, the electronic device 101 detects and responds to input for adding clips (e.g., video and/or audio clips), to the primary timeline 420 by adding the clips to primary timeline 420 in response to the input. For example, in FIG. 4, trimmed clip representation 401a is optionally being displayed outside of primary timeline 420, and in response to detecting a request for movement of trimmed clip representation 401a from its location in FIG. 4 to a location in the primary timeline 420 in FIG. 5, the electronic device 101 optionally moves the trimmed clip representation 401a in accordance with the request to the location in the primary timeline 420.

In some examples, the electronic device 101 detects and responds to input for editing and/or arranging the clips in the primary timeline 420 by editing and/or arranging the clips in the primary timeline 420 in accordance with the input. In some examples, more, fewer, or the same amount of media editing operations can be performed on trimmed clip representation 401a (or the clip representation 401) that were described with reference to FIG. 4. For example, in FIG. 5, the electronic device 101 displays clip start indicator 404a and clip end indicator 404b for trimming clips, such as described with reference to FIG. 4, and in response to detecting input for trimming clip representation 402a, the electronic device 101 optionally moves the clip start indicator 404a and/or clip end indicator 404b in accordance with the input.

In the illustrated example of FIG. 5, primary timeline 420 includes a scrubber bar 428 that is selectable to adjust the start frame and end frame of the clip, without changing the position in the primary timeline of the clip representation. For example, clip start indicator 404a is optionally at primary timeline frame 100, and represents a clip that starts at clip frame 20. Continuing with this example, input directed to scrubber bar 428 may result in clip start indicator 404a being moved to represent clip frame 25 instead of clip frame 20, but still at primary-timeline frame 100.

In the illustrated example of FIG. 5, the electronic device 101 displays a preview user interface 408a on the clip representation 402. In some examples, preview user interface 408a shows a frame of the trimmed clip representation 401a at the current position of the playhead 406. In some examples, the frame shown in preview user interface 408a is not associated with the frame that is at the current position of the playhead 406. In some examples, preview user interface 408a in FIG. 5 shows a frame associated with the trimmed clip representation 401a and “IMG_007” in FIG. 5 is a textual representation of the trimmed clip representation 401a. In some examples, preview user interface 408a includes one or more features of the media clip user interface 408 of FIG. 4. Note that in some examples the view of primary timeline 420 in FIG. 5 is a more detailed view of clip representation 401 of FIG. 4 in a primary timeline.

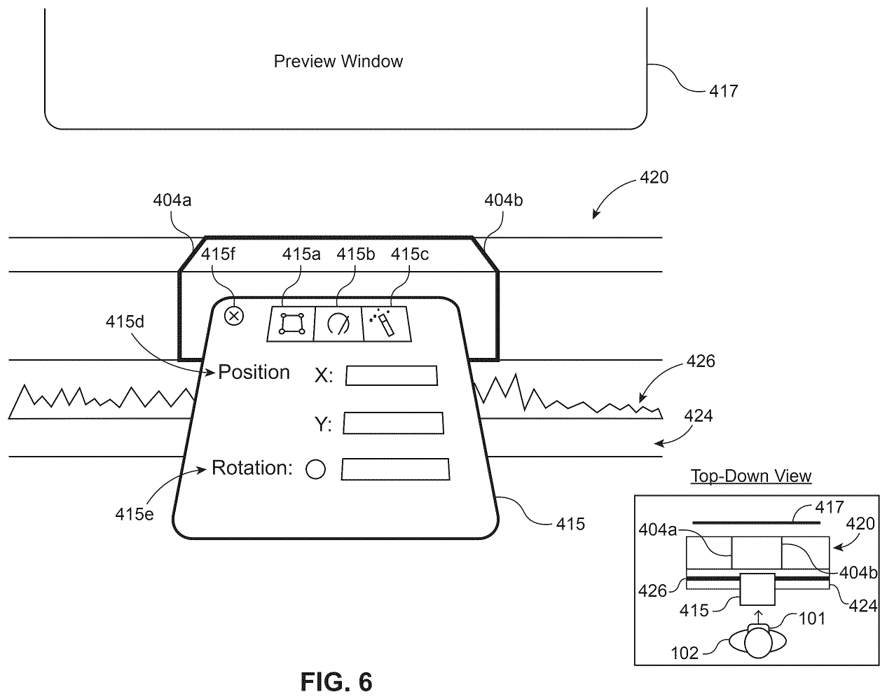

FIG. 6 illustrates an example of an electronic device displaying a video editing user interface for adjusting clip attributes according to some examples of the disclosure.

In the illustrated example of FIG. 6, the electronic device 101 concurrently displays primary timeline 420, a video editing user interface 415, and a preview window 417. The preview window 417 optionally shows a frame associated with trimmed clip representation 401a at the position of the playhead 406. In some examples, preview window 417 includes one or more features of the media clip user interface 408 of FIG. 4 and/or of the preview user interface 408a of FIG. 5. In some examples, preview window 417 of FIG. 6 is the same as described with reference to media clip user interface 408 of FIG. 4. The video editing user interface 415 includes controls 415a-415c. Control 415a is optionally selectable to display a menu for positioning (e.g., resizing, moving (e.g., left, right, up, down), and/or rotating) one or more frames associated with the trimmed clip representation 401a (e.g., the frame displayed in preview window 417). Control 415b is optionally selectable to display a menu for setting a playback speed of the trimmed clip (to which trimmed clip representation 401a corresponds). Control 415c is optionally selectable to display a menu for viewing and/or modifying color characteristics of a clip (e.g., applying color correction techniques to the clip or another enhancement technique). In FIG. 6, control 415a is optionally selected and the video editing user interface 415 shows controls 415d and 415e because control 415a is selected. Control 415d is optionally selectable to move the image horizontally (e.g., left or right) or vertically (e.g., up or down). Control 415e is optionally selectable to rotate the image. The video editing user interface 415 also includes control 415f, which is optionally selectable to cease display of the video editing user interface 415. For example, in FIG. 6, if the electronic device 101 were to detect input corresponding to selectable of control 415f, the electronic device 101 would optionally cease display of the video editing user interface 415 and maintain display of the preview window 417 and primary timeline 420. In some examples, the electronic device 101 displays the video editing user interface 415 having a first predetermined spatial relationship with the location of the clip to which the video editing user interface 415 corresponds, such that if the clip in the primary timeline 420 is being displayed at a first location in the three-dimensional environment, then the video editing user interface 415 would be displayed at a second location in the three-dimensional environment that has the first predetermined spatial relationship with the clip, and if the clip in the primary timeline 420 is being displayed at a third location in the three-dimensional environment, different from the first location, then the video editing user interface 415 would be displayed at a fourth location, different from the second location, in the three-dimensional environment that has the predetermined spatial relationship. In some examples, the electronic device 101 displays an audio effect editing user interface include one or more controls that are selectable to edit, enhance, and/or apply effects to audio clips. In some examples, the illustrated location of the video editing user interface 415 in FIG. 6 is a default location. In some examples, the illustrated location of the video editing user interface 415 in FIG. 6 is in accordance with user input. Note that the electronic device 101 may detect and respond to input from the user requesting movement of the video editing user interface 415 from a first location in the three-dimensional environment to a second location in the three-dimensional environment by moving the video editing user interface 415 from the first location to the second location in accordance with the input.

In some cases, a user may desire to create alternative timelines (e.g., secondary timelines, alternative events and/or alternative sequences of event) that branch from primary timeline 420 (e.g., that branch from a time position in primary timeline 420). In some examples, the electronic device 101 displays an additional control in video editing user interface 415 in FIG. 6 that is selectable to create an alternative timeline at the time position in the primary timeline 420 that corresponds to the frame in the preview window 417. The electronic device 101 may detect and respond to input for creating alternative timelines, such as shown in FIGS. 7-9.

FIG. 7 illustrates an example of an electronic device displaying a timeline branching user interface element in a primary timeline and displaying a media clip user interface for defining portions of media in the primary timeline as selectable to display alternative timelines during a runtime of the media project according to some examples of the disclosure.

In the illustrated example of FIG. 7, the electronic device 101 displays timeline branching user interface element 430 in the primary timeline 420. In some examples, the electronic device 101 displays timeline branching user interface element 430 in response to input directed to a control that is selectable to create an alternative timeline, such as described above. In some examples, the location of the timeline branching user interface element 430 in the primary timeline 420 corresponds to a time position associated with input to create alternative timelines. For example, the input optionally includes a specific frame and/or time position in primary timeline 420 to place the timeline branching user interface element 430. In some examples, the electronic device detects and responds to input for moving the timeline branching user interface element 430 in the primary timeline 420 by moving the timeline branching user interface element 430 in the primary timeline 420 in accordance with the input. In some examples, timeline branching user interface element 430 is a three-dimensional object. In some examples, a shape of the timeline branching user interface element 430 is similar to a shape of a clip in the primary timeline 420. In some examples, a shape of the timeline branching user interface element 430 is different from a shape of a clip representation in the primary timeline 420. Note that in FIGS. 7-9, the primary timeline 420 is optionally filled with one or more video and/or audio clip representations (e.g., is filled with a sequence of video and/or clips).

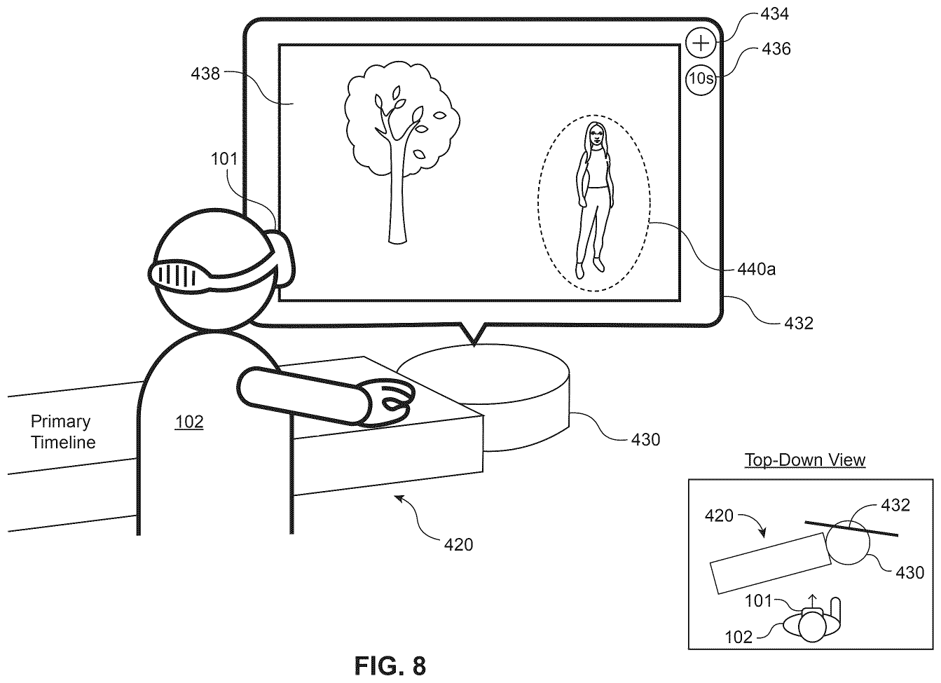

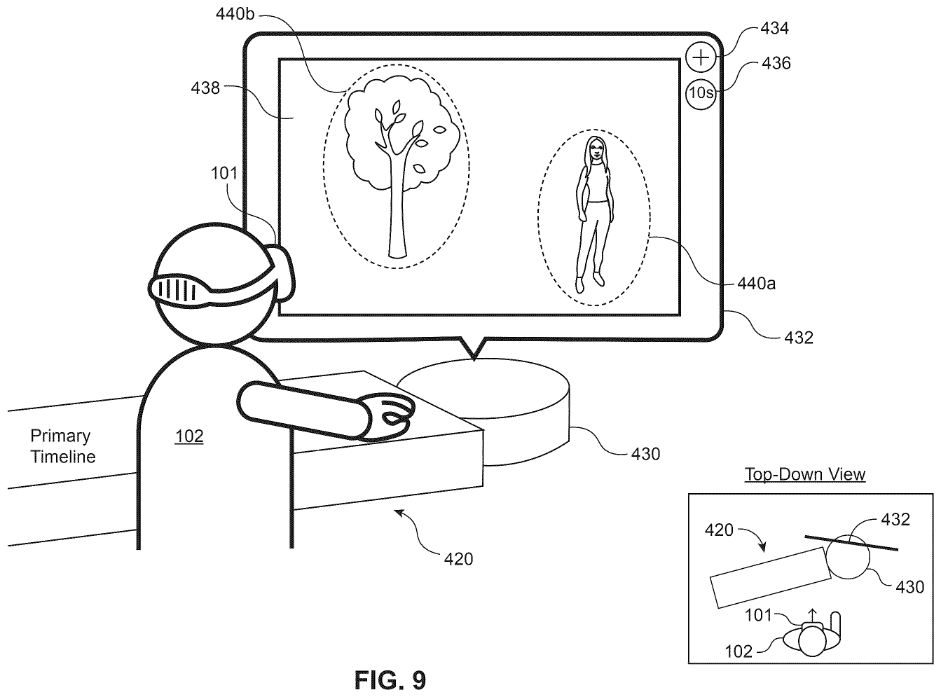

In the illustrated example of FIG. 7, the electronic device 101 displays an alternative timeline editing user interface 432. The alternative timeline editing user interface 432 includes controls for defining a number of alternative timelines that are to be created. In some examples, a number of alternative timelines that are to be created is based on an amount of selection zones defined by input (e.g., user input) directed to the alternative timeline editing user interface 432. For example, the alternative timeline editing user interface 432 includes a frame that is in primary timeline 420 at the time position of the timeline branching user interface element 430 in the primary timeline 420, and the selection zones are defined and/or edited as shown in the frame in the alternative timeline editing user interface 432, as will be shown in FIGS. 8 and 9.

For example, FIG. 8 illustrates an example of electronic device 101 detecting and responding to input (e.g., user input optionally including gaze and/or input from the hand of the user directed to the frame in the alternative timeline editing user interface 432) for defining a first selection zone 440a in the frame, and FIG. 9 illustrates an example of the electronic device 101 detecting and responding to input (e.g., user input optionally including gaze and/or input from the hand of the user directed to the frame in the alternative timeline editing user interface 432) for defining a second selection zone 440b in the frame. In some examples, the electronic device 101 displays the alternative timelines branching from the primary timeline 420 in response to detecting the input for defining a respective selection zone. For example, in response to detecting the input for defining the first selection zone 440a in FIG. 8, the electronic device 101 optionally adds to the primary timeline 420 a first alternative timeline, and in response to detecting the input for defining the second selection zone 440b in FIG. 9, after detecting the input for defining the first selection zone 440a in FIG. 9, the electronic device optionally adds to the primary timeline 420 a second alternative timeline, such that the primary timeline 420, timeline branching user interface element 430, the alternative timeline editing user interface 432, the first alternative timeline, and the second alternative timeline are concurrently displayed.

In some examples, the electronic device 101 displays a plurality of timelines, such as shown in FIG. 11. In the illustrated example of FIG. 11, the electronic device 101 displays three alternative timeline branches that branch from the timeline branching user interface element 430 and that coalesce into the timeline coalescing user interface element 460. In particular, in FIG. 11, the electronic device 101 displays first alternative timeline branch 430a, second alternative timeline branch 430b, and third alternative timeline branch 430c. The electronic device can detect and respond to input for adding clips (e.g., image and/or audio clips) into a respective alternative timeline branch by adding clips into the respective alternative timeline branch in accordance with the input, such as described with reference to adding clips into the primary timeline 420 in FIG. 5. The operations described with reference to the adding, arranging, and/or editing of clips in FIGS. 4-6 can be performed in the respective alternative timeline branch in accordance with similar inputs directed to the respective alternative timeline branch. In some examples, FIG. 11 includes the same number of alternative timelines defined in FIG. 9. In some examples, the first alternative timeline that is associated with the first selection zone 440a in FIG. 9 is first alternative timeline branch 430a in FIG. 11 and the second alternative timeline that is associated with the second selection zone 440b in FIG. 9 is the second alternative timeline branch 430b in FIG. 11. In some examples, the third alternative timeline branch 430c in FIG. 11 is a default timeline branch and is described in more detail later below. In FIG. 11, the electronic device displays clip representations 442b of clips are in the second alternative timeline branch 430b and clip representations 442b are in the first alternative timeline branch 430a. In some examples, the electronic device 101 added clip representations 442b to the second alternative timeline branch 430b in response to detecting input for adding the clip representations 442b to the second alternative timeline branch 430b, such as described with reference to the adding of the trimmed clip representation 401a to the primary timeline 420 from FIG. 4 to FIG. 5. Similarly, in some examples, the electronic device 101 added clip representations 442a to the first alternative timeline branch 430a in response to detecting input for adding the clip representations 442a to the first alternative timeline branch 430a, such as described with reference to the adding of the trimmed clip representation 401a to the primary timeline 420 from FIG. 4 to FIG. 5. Returning to FIG. 11, the timeline coalescing user interface element 460 visually coalesces the alternative timelines at a second time position of media project. In some examples, the electronic device 101 detects and responds to input for moving the timeline coalescing user interface element 460 by moving the timeline coalescing user interface element 460 in accordance with the input. In some examples, the timeline coalescing user interface element 460 is displayed at a default location in response to display of the timeline branching user interface element 430 in the primary timeline 420. In some examples, the electronic device 101 moves the timeline coalescing user interface element 460 such that its location is at the final time position of the last clip that corresponds to the longest branch of the alternative timelines (or such that its location is at a position corresponding to the first frame of primary timeline 420 after the last time position of the last clip of the longest branch). For example, in FIG. 11, the second alternative timeline is the longest in length, so the electronic device 101 optionally displays the timeline coalescing user interface element 460 at the last time position of the second alternative timeline branch 430b. In this way, the location of the timeline coalescing user interface element 460 is optionally indicates an ending of the branching of timelines from the primary timeline 420.

Note that when the frame associated with the alternative timeline editing user interface 432 of FIG. 9 is displayed during a runtime of the media project (e.g., during playback of the media project by a media runtime application, which is optionally different from a media editing application that created and/or edited the media project), if an electronic device were to detect input (e.g., gaze of the user) directed to the first selection zone 440a of the frame, the electronic device would proceed to presenting an alternative storyline in the media project that is in accordance with a first alternative timeline (e.g., would proceed to present content (e.g., audio and/or video content) that is in the first alternative timeline), and if the electronic device 101 were to detect input (e.g., gaze of the user) directed to the second selection zone 440b when the frame is displayed, the electronic device 101 would proceed to presenting another alternative storyline in the media project that is in accordance with a second alternative timeline (e.g., would proceed to present content (e.g., audio and/or video content) that is in the second alternative timeline), different from the first alternative timeline. In some examples, the selection zones of FIG. 9 are selectable via gaze during runtime of the media project, such as described with reference to FIG. 11. Returning back to FIG. 9, in some examples, the electronic device 101 detects and responds to input for creating, resizing, moving, and/or deleting the selection zones by creating, resizing, moving, and/or deleting the selection zones in accordance with the input. In some examples, when the alternative timeline editing user interface 432 of FIG. 9 is displayed, the preview window 417 of FIG. 6 is not displayed (e.g., the media editor environment may restrict concurrent display of the preview window 417 and the alternative timeline editing user interface 432). In some examples, when the alternative timeline editing user interface 432 of FIG. 9 is displayed, the preview window 417 of FIG. 6 is displayed (e.g., the media editor environment may allow concurrent display of the preview window 417 and the alternative timeline editing user interface 432).

In FIGS. 7-9, the alternative timeline editing user interface 432 also includes control 434 and control 436. Control 436 is optionally selectable to modify an amount of time associated with a selectable portion being selectable to display an alternative timeline. For example, the selectable portion is optionally selectable before a time position corresponding to the branching of timelines is reached, and control 436 optionally indicates the amount of time during which gaze can be detected at a portion. In some examples, even though during playback the displayed frame changes in accordance with the playback of the media project, the defined portion(s) (e.g., of the user interface that corresponds to alternative storylines) optionally remains selectable for a threshold period of time (e.g., 1 s, 3 s, 7 s, 10 s, 20 s, or another threshold period of time) during which the electronic device 101 can determine which storyline (e.g., alternative timeline) to display based on the gaze selection of the user. For example, as described above, in some examples, the selection zones are selectable via gaze during runtime of the media project, and if the electronic device detect that the gaze of the user is directed to the first selection zone during which the first selection zone is selectable, then the electronic device would proceed to present content that is in the first alternative timeline, and if the electronic device detects that the gaze is directed to the second selection zone during which the second selection zone is selectable, then the electronic device would proceed to present content that is in the second alternative timeline. Control 434 is optionally selectable to cease display of the alternative timeline editing user interface 432. In some examples, the electronic device 101 displays timeline branching user interface element 430 in the primary timeline 420 without display of the alternative timeline editing user interface 432, as shown in FIGS. 7-9. In some examples, the electronic device 101 displays timeline branching user interface element 430 in the primary timeline 420 without display of the alternative timeline editing user interface 432, as shown in FIGS. 11, 12, and 14-16.

In some examples, the electronic device 101 detects and responds to input for deleting the timeline branching user interface element 430 in the in primary timeline 420 by deleting the timeline branching user interface element 430 in the primary timeline 420. Note that deletion of the timeline branching user interface element 430 may not result in deletion of all timeline content in the alternative timelines that branched from the timeline branching user interface element 430. In some examples, the electronic device creates (e.g., automatically) a default timeline so that a timeline is present at the time position that the timeline branching user interface element 430 even if the timeline branching user interface element 430 is deleted. In some examples, the default timeline is created in response to insertion of the timeline branching user interface element 430 into the primary timeline 420.

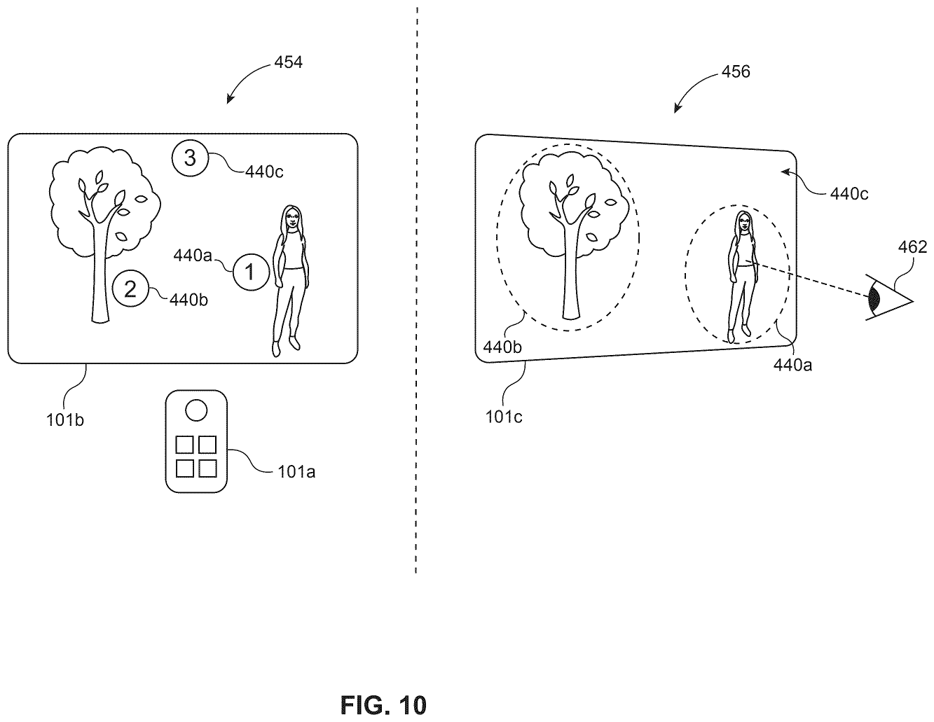

FIG. 10 illustrates alternative examples of timeline selection during a runtime of a media project according to some examples of the disclosure.

In the illustrated example of FIG. 10, a device 101a (e.g., optionally including one or more features of electronic device 101) is displaying a media project in runtime. The media project was optionally created by the electronic device 101, such as described with reference to FIGS. 4-9, and includes alternative timelines. For example, the illustrated frame in FIG. 10 is optionally a frame in the primary timeline of the media project to which the selection zones are active. The selection zones optionally include selection zone 440a corresponding to a first alternative timeline, selection zone 440b corresponding to second alternative timeline, different from the first alternative timeline, and a third selection zone 440c corresponding to a third alternative timeline, different from the first and second alternative timelines.

In the illustrated example of FIG. 10, in first case 454, device 101a (e.g., a device including one or more features of the electronic device 101) is displaying the frame associated with the timeline branching user interface element 430 in FIG. 9 (e.g., the device 101c is displaying the media project in a media playback application, such as a media runtime application, which is optionally different from a media editing application). For example, the display device was optionally playing the media project and the time position of the media project has reached the time position associated with the frame associated with the timeline branching user interface element 430 in FIG. 9. In response, in first case 454, the media project is paused, and the device 101a responds to input provided via device 101b (e.g., a remote control device, or another device that may include one or more features of the electronic device 101), which is in communication with device 101a for selecting a timeline for procession of the media project. In some examples, the device 101b associates specific buttons on the device 101b to specific timelines, such that if a first button of the device 101b is selected, then the device 101b would cause procession of the media project in accordance with a first alternative timeline, if a second button, different from the first button, of the device 101b is selected, then the device 101b would cause procession of the media project in accordance with a second alternative timeline, different from the first timeline, and if a third button, different from the first and second buttons, of the device 101b is selected, then the device 101b would cause procession of the media project in accordance with a third alternative timeline, different from the first and second alternative timelines. In some examples, the device 101b includes a selector such as a rotatable dial or knob and the user may select different alternative timelines based on input directed to the rotatable dial or knob.

In the illustrated example of FIG. 10, in second case 456, device 101c (e.g., a device including one or more features of the electronic device 101) is displaying the frame associated with the timeline branching user interface element 430 in FIG. 9 (e.g., the device 101c is displaying the media project in a media playback application, such as a media runtime application, which is optionally different from a media editing application). For example, the device 101c is optionally playing the media project and the time position of the media project has reached the time position associated with the frame associated with the timeline branching user interface element 430 in FIG. 9. In response, the device 101c optionally maintains the playing of the media project and can detect and respond to input (e.g., gaze 462 of the user, gaze 462 and input from the hand of the user, and/or another user input) for selecting a timeline for procession of the media project. For example, if the gaze 462 is directed to the image data corresponding to the first selection zone 440a, then the device 101c would proceed to playback of the media project to display content that is in the first alternative timeline, if the gaze 462 is directed to the image data corresponding to the second selection zone 440b, then the device 101c would proceed to playback of the media project to display content that is in the second alternative timeline, and if the gaze 462 is directed to the third selection zone 440c, then the device 101c would proceed to playback of the media project to display content that is in the third alternative timeline. In some examples, if gaze 462 is not detected as being directed to first selection zone 440a, second selection zone 440b, or third selection zone 440c, the device 101c optionally automatically selects a timeline to proceed with playback of the media project such that the playback state of the media project is maintained without changing (e.g., without pausing). In some examples, the device 101c does not maintain the playing of the media project when it has reached the time position associated with the frame associated with the timeline branching user interface element 430 in FIG. 9, but pauses or otherwise changes in playback status, during which the user may select a timeline.

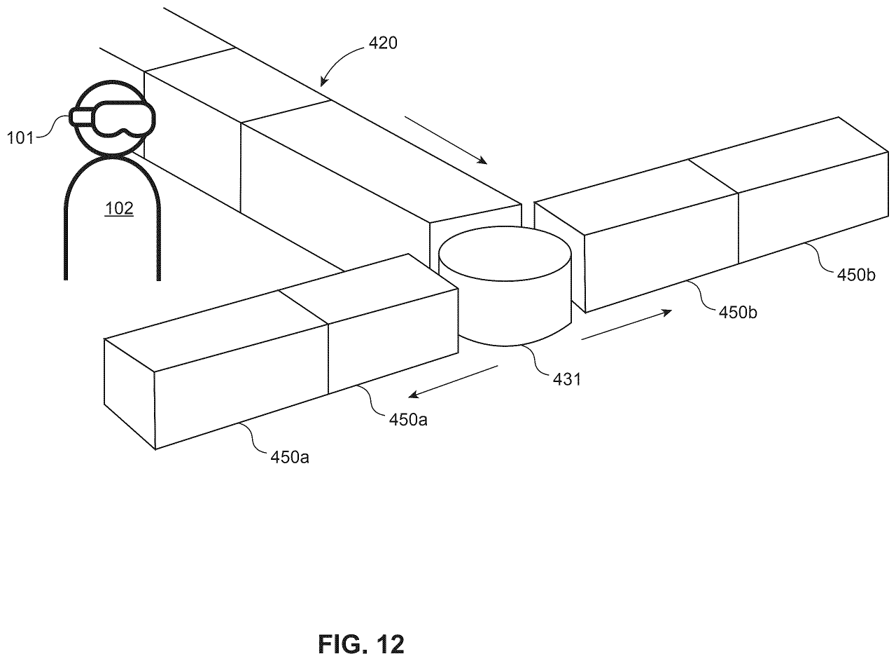

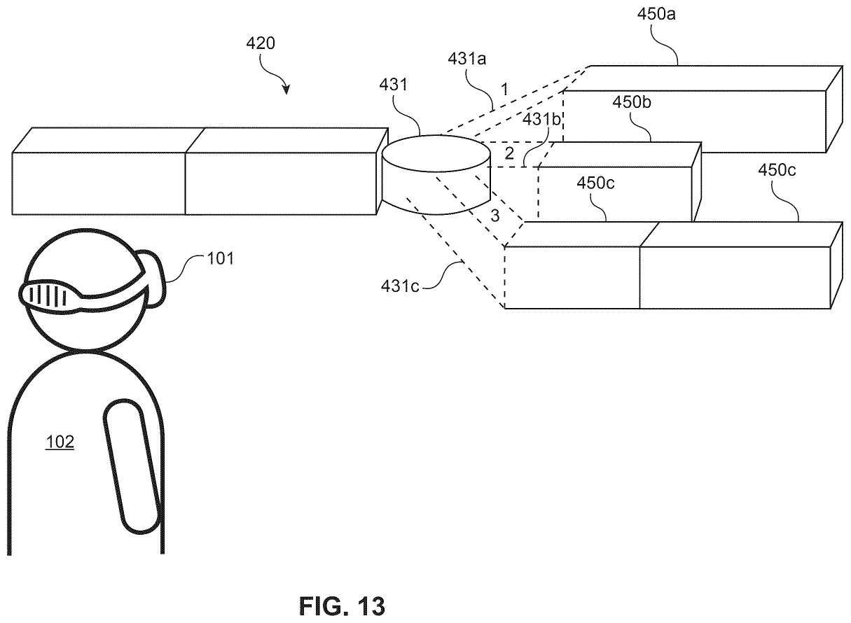

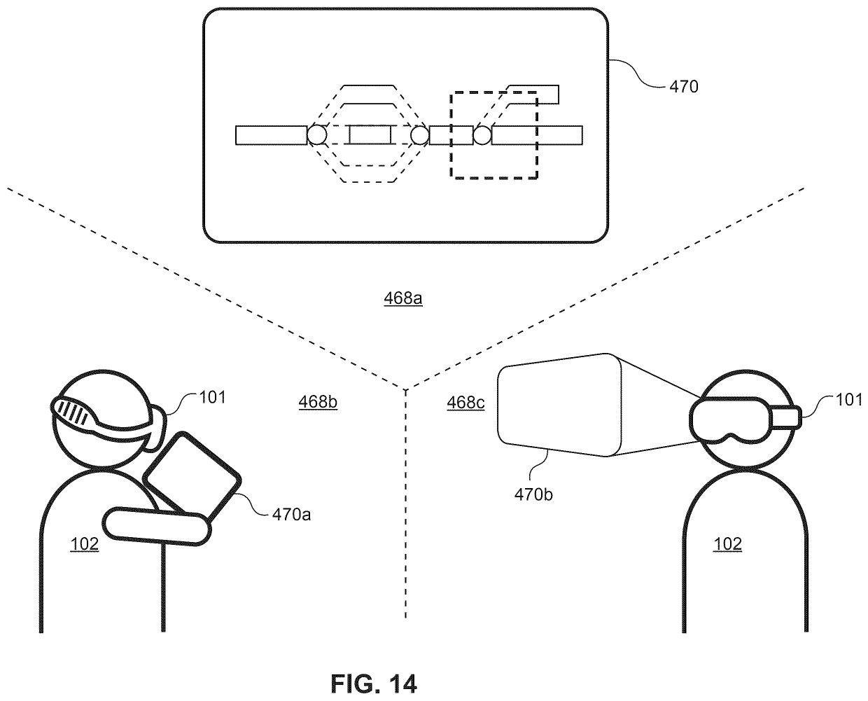

FIGS. 12 and 13 illustrate examples of an electronic device displaying primary timeline 420 with different amounts of branching timelines according to some examples. In FIG. 12, the electronic device 101 displays primary timeline 420, a timeline branching user interface element 431, and alternative timelines 431a/431b, which include clips representations 450a/450b, respectively. In the illustrated example of FIG. 13, the electronic device 101 displays primary timeline 420, a timeline branching user interface element 431, and alternative timelines 431a-431c, which include clip representations 450a-450c, respectively. In some examples, primary timeline 420 in FIG. 13 includes more portions that illustrated in FIG. 13. In some examples, though the media project may include additional clips and/or time positions, the electronic device 101 can selectively display portions of the timeline to conserve computing resources used for displaying the media editing environment and to converse space used for displaying the media editing environment. In some examples, the electronic device selectively displays portions the timeline in accordance with user input, such as described with to FIG. 14.

FIG. 14 illustrates an example of an electronic device displaying a timeline representation 470 according to some examples of the disclosure. Side 468a in FIG. 14 is an example illustration of the timeline representation 470, side 468b in FIG. 14 shows timeline representation 470 being displayed by electronic device 101 in a first location relative to the user 102, and side 468c shows timeline representation 470 being displayed by electronic device 101 in a second location relative to the user 102. In some examples, the timeline representation 470 is a map or outline of the timeline (e.g., of a full timeline of a media project). In some examples, the representation of the timeline is a two-dimensional representation of the timeline of the media project. In some examples, the electronic device 101 displays the timeline representation 470 in response to input detected at the electronic device 101 and/or at a device that is in communication with the electronic device (e.g., at device 101b of FIG. 10). In some examples, the timeline representation 470 is of a first size smaller than a portion of the primary timeline, such as the timeline representation 470 being smaller than the illustrated portions of primary timeline 420 illustrated in FIG. 13 displayed in the media editing environment. In some examples, the timeline representation 470 selectable to display different portions of the timeline. For example, when the illustrated portions of primary timeline 420 illustrated in FIG. 13 is displayed, the electronic device detects an input requesting display of timeline representation 470, and in response the electronic device displays timeline representation 470 (optionally concurrently with display of primary timeline 420 or without display of primary timeline). Continuing with this example, while the timeline representation 470 in FIG. 14 is being displayed, if the electronic device 101 were to detection user selection requesting display at the size of the primary timeline 420 in FIG. 13 a different portion of the primary timeline than the illustrated portion in FIG. 13, then the electronic device 101 would optionally display in response the selected portion at the same corresponding size as the size of the portion of the primary timeline 420 in FIG. 13.

FIGS. 15 and 16 illustrate an example of an electronic device detecting and responding to input for moving playhead 406 (e.g., a current playback position indicator) in a timeline according to some examples of the disclosure. In FIG. 15, while the playhead 406 is at the illustrated position in primary timeline 420, the electronic device 101 detects input from the user requesting movement of the playhead 406 from the illustrated position in FIG. 15 to the illustrated position in FIG. 16, which is a position in alternative timeline 450a. In response, the electronic device 101 moves the playhead 406 to the illustrated position in FIG. 16. In some examples, a preview window (e.g., the preview window 417 in FIG. 6) is currently displayed with the timeline and moves in accordance with the movement of the playhead 406. In some examples, the preview window remains fixed in location when the playhead 406 is moved. Additionally or alternatively, in some examples, a preview window showing the current frame at the position of playhead 406 is displayed over the playhead 406 (e.g., at the location of the playhead 406) and moves in accordance with movement of the playhead (e.g., to maintain a spatial relationship between the playhead 406 and the preview window).

It is understood that the examples shown and described herein are merely exemplary and that additional and/or alternative elements may be provided within the three-dimensional environment for interacting with the illustrative content. It should be understood that the appearance, shape, form and size of each of the various user interface elements and objects shown and described herein are exemplary and that alternative appearances, shapes, forms and/or sizes may be provided. Additionally or alternatively, in some examples, the various options, user interface elements, control elements, etc. described herein may be selected and/or manipulated via user input received via one or more separate input devices in communication with the electronic device(s). For example, selection input may be received via physical input devices, such as a mouse, trackpad, keyboard, etc. in communication with the electronic device(s).

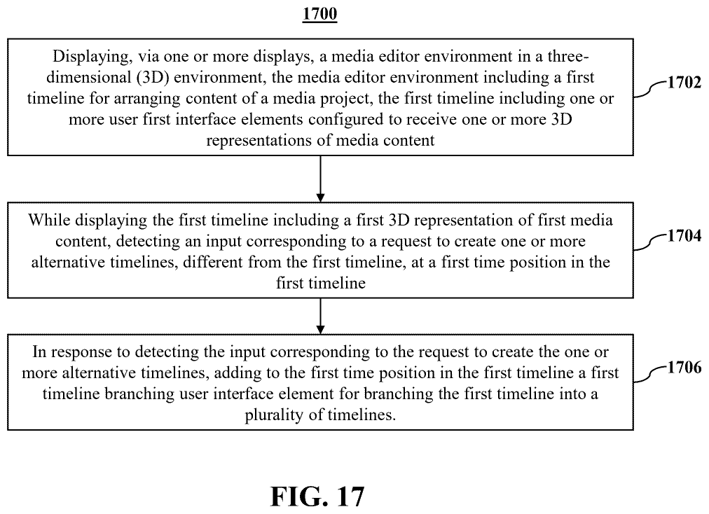

FIG. 17 is a flow diagram illustrating a method 1700 for adding a timeline branching user interface element for branching a first timeline into a plurality of timelines according to some examples of the disclosure. It is understood that method 1700 is an example and that more, fewer, or different operations can be performed in the same or in a different order. Additionally, the operations in method 1700 described below are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method (e.g., method 1700 of FIG. 17) comprising, at an electronic device in communication with one or more input devices and one or more displays, displaying (1702), via the one or more display devices, a media editor environment in a three-dimensional (3D) environment, the media editor environment including a first timeline for arranging content of a media project, the first timeline including one or more first user interface elements configured to receive one or more 3D representations of media content, while displaying the first timeline including a first 3D representation of first media content, detecting (1704) an input corresponding to a request to create one or more alternative timelines, different from the first timeline, at a first time position in the first timeline, and in response to detecting the input corresponding to the request to create the one or more alternative timelines, adding (1706) to the first time position in the first timeline a first timeline branching user interface element for branching the first timeline into a plurality of timelines

Additionally or alternatively, in some examples, the one or more first user interface elements include a first respective user interface element for receiving a 3D representation of a video clip and a second respective user interface element for receiving a 3D representation of an audio clip.

Additionally or alternatively, in some examples, method 1700 includes in response to receiving the 3D representation of the video clip, displaying, via the one or more displays, the 3D representation of the video clip having a first appearance in the first timeline, and in response to receiving the 3D representation of the audio clip, displaying, via the one or more displays, the 3D representation of the audio clip having a second appearance, different from the first appearance, in the first timeline.

Additionally or alternatively, in some examples, the second appearance is a waveform of an audio amplitude of the audio clip over time in the first timeline.

Additionally or alternatively, in some examples, method 1700 includes detecting a request to display a respective portion of the first timeline, and in response detecting the request to display the respective portion of the first timeline, in accordance with a determination that the respective portion is a first portion of the first timeline, displaying, via the one or more displays, the first portion of the first timeline without displaying a second portion of the first timeline, and in accordance with a determination that the respective portion is the second portion of the first timeline, displaying, via the one or more displays, the second portion of the first timeline without displaying the first portion of the first timeline.

Additionally or alternatively, in some examples, method 1700 includes after adding the first timeline branching user interface element for branching the first timeline into the plurality of timelines to the first time position in the first timeline, detecting a request to delete the first timeline branching user interface element, and in response to detecting the request to delete the first timeline branching user interface element, deleting the first timeline branching user interface element, and the one or more alternative timelines or one or more of the one or more alternative timelines.

Additionally or alternatively, in some examples, method 1700 comprises while displaying the first timeline, displaying, via the one or more displays, a media editing user interface for editing a clip in the first timeline wherein in accordance with a determination that a 3D representation of the clip is at a first location, displaying the media editing user interface for editing media in the first timeline includes displaying the media editing user interface at a first position that has a first spatial relationship relative to the first location and in accordance with a determination that the 3D representation of the clip is in at second location, different from the first location, displaying the media editing user interface for editing media in the first timeline includes displaying the media editing user interface at a second position, different from the first position, that has the first spatial relationship relative to the second location.

Additionally or alternatively, in some examples, method 1700 includes in response to detecting the input corresponding to the request to create the one or more alternative timelines, updating display, via the one or more displays, of the media editor environment to include a user interface including a second representation of the first media content associated with the first time position in the first timeline, and one or more user interface elements for defining one or more portions of the second representation of the first media content as selectable to display one or more respective timelines of the plurality of timelines during a runtime of the media project, wherein a number of timelines in the plurality of timelines is based on a number of the one or more portions.

Additionally or alternatively, in some examples, a respective portion of the one or more portions is selectable during a runtime of the media project via detection of gaze of a user directed to the respective portion

Additionally or alternatively, in some examples, method 1700 includes after detecting the input corresponding to the request to create the one or more alternative timelines, updating display, via the one or more displays, of the media editor environment to include a timeline coalescing user interface element that coalesces the plurality of timelines at a second time position in the first timeline after the first time position in the first timeline.

Additionally or alternatively, in some examples, method 1700 includes detecting an input corresponding to a request to add to the first timeline a timeline coalescing user interface element that coalesces the plurality of timelines at a second time position in the first timeline after the first time position in the first timeline, and in response to detecting the input corresponding to the request to add the timeline coalescing user interface element, adding the timeline coalescing user interface element to the first timeline, including displaying the plurality of timelines coalescing into the timeline coalescing user interface element.

Additionally or alternatively, in some examples, the plurality of timelines includes a first alternative timeline and a second alternative timeline, different from the first alternative timeline.

Additionally or alternatively, in some examples, method 1700 includes detecting an input corresponding to a request to add a second 3D representation of second media content, different from the first 3D representation of first media content, to the second alternative timeline, in response to detecting the input corresponding to the request to add the second 3D representation of second media content to the second alternative timeline, adding the second 3D representation of second media content to the second alternative timeline, and after adding the second 3D representation of second media content to the second alternative timeline, updating display, via the one or more displays, of the media editor environment to include the first timeline having the first 3D representation of the first media content, the first alternative timeline, and the second alternative timeline having the second 3D representation of the second media content.

Additionally or alternatively, in some examples, the media project includes the first timeline including the first media content, a first alternative timeline branching from the first timeline, the first alternative timeline including first alternative media content, a second alternative timeline branching from the first timeline, the second alternative timeline including second alternative media content. Additionally or alternatively, in some examples, the method 1700 includes during a runtime of the media project while displaying media content of the first timeline associated with the first time position in the first timeline, detecting a gaze of a user directed to a respective portion of the media content, and in response to detecting the gaze of the user, in accordance with a determination that the respective portion of the first media content is a first portion, causing display of the first alternative media content, and in accordance with a determination that the respective portion of the first media content is a second portion different from the first portion, causing display of the second alternative media content.

Additionally or alternatively, in some examples, when the gaze of the user is detected, the media project is in a first state of playback, and in response to the detecting the gaze of the user, the media project is in the first state of playback.

Additionally or alternatively, in some examples, displaying the media editor environment includes displaying a preview window for previewing content of the first timeline.

Additionally or alternatively, in some examples, the plurality of timelines includes a default timeline that is created in response to detecting the input corresponding to the request to create the one or more alternative timelines.

Additionally or alternatively, in some examples, the one or more displays are part of a head-mounted display system.

Additionally or alternatively, in some examples, the plurality of timelines includes a first alternative timeline, a second alternative timeline, different from the first alternative timeline, and a third alternative timeline, different from the first alternative timeline and the second alternative timeline.

Some examples of the disclosure are directed to an electronic device comprising: one or more processors, memory, and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the first electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

What is claimed is:

1. A method comprising:
at an electronic device in communication with one or more input devices and one or more displays:
displaying, via the one or more displays, a media editor environment in a three-dimensional (3D) environment, the media editor environment including:
a first timeline for arranging content of a media project, the first timeline including one or more first user interface elements configured to receive one or more 3D representations of media content;
while displaying the first timeline including a first 3D representation of first media content, detecting an input corresponding to a request to create one or more alternative timelines, different from the first timeline, at a first time position in the first timeline; and
in response to detecting the input corresponding to the request to create the one or more alternative timelines, adding to the first time position in the first timeline a first timeline branching user interface element for branching the first timeline into a plurality of timelines.

2. The method of claim 1, wherein the one or more first user interface elements include:
a first respective user interface element for receiving a 3D representation of a video clip; and
a second respective user interface element for receiving a 3D representation of an audio clip.

3. The method of claim 2, comprising:
in response to receiving the 3D representation of the video clip, displaying, via the one or more displays, the 3D representation of the video clip having a first appearance in the first timeline; and
in response to receiving the 3D representation of the audio clip, displaying, via the one or more displays, the 3D representation of the audio clip having a second appearance, different from the first appearance, in the first timeline.

4. The method of claim 3, wherein the second appearance is a waveform of an audio amplitude of the audio clip over time in the first timeline.

5. The method of claim 1, comprising:
detecting a request to display a respective portion of the first timeline; and
in response detecting the request to display the respective portion of the first timeline:
in accordance with a determination that the respective portion is a first portion of the first timeline, displaying, via the one or more displays, the first portion of the first timeline without displaying a second portion of the first timeline; and
in accordance with a determination that the respective portion is the second portion of the first timeline, displaying, via the one or more displays, the second portion of the first timeline without displaying the first portion of the first timeline.

6. The method of claim 1, comprising:
after adding the first timeline branching user interface element for branching the first timeline into the plurality of timelines to the first time position in the first timeline, detecting a request to delete the first timeline branching user interface element; and
in response to detecting the request to delete the first timeline branching user interface element, deleting:
the first timeline branching user interface element; and
the one or more alternative timelines or one or more of the one or more alternative timelines.

7. The method of claim 1, comprising:
while displaying the first timeline, displaying, via the one or more displays, a media editing user interface for editing a clip in the first timeline, wherein:
in accordance with a determination that a 3D representation of the clip is at a first location, displaying the media editing user interface for editing media in the first timeline includes displaying the media editing user interface at a first position that has a first spatial relationship relative to the first location; and
in accordance with a determination that the 3D representation of the clip is in at second location, different from the first location, displaying the media editing user interface for editing media in the first timeline includes displaying the media editing user interface at a second position, different from the first position, that has the first spatial relationship relative to the second location.

8. A non-transitory computer readable storage medium storing one or more programs, the one or more programs comprising instructions, which when executed by one or more processors of an electronic device, cause the electronic device to perform a method comprising:
displaying, via one or more displays of the electronic device, a media editor environment in a three-dimensional (3D) environment, the media editor environment including:
a first timeline for arranging content of a media project, the first timeline including one or more user first interface elements configured to receive one or more 3D representations of media content;
while displaying the first timeline including a first 3D representation of first media content, detecting an input corresponding to a request to create one or more alternative timelines, different from the first timeline, at a first time position in the first timeline; and
in response to detecting the input corresponding to the request to create the one or more alternative timelines, adding to the first time position in the first timeline a first timeline branching user interface element for branching the first timeline into a plurality of timelines.

9. The non-transitory computer readable storage medium of claim 8, wherein the method comprises:
in response to detecting the input corresponding to the request to create the one or more alternative timelines, updating display, via the one or more displays, of the media editor environment to include a user interface including:
a second representation of the first media content associated with the first time position in the first timeline; and
one or more user interface elements for defining one or more portions of the second representation of the first media content as selectable to display one or more respective timelines of the plurality of timelines during a runtime of the media project,
wherein a number of timelines in the plurality of timelines is based on a number of the one or more portions.

10. The non-transitory computer readable storage medium of claim 9, wherein a respective portion of the one or more portions is selectable during a runtime of the media project via detection of gaze of a user directed to the respective portion.

11. The non-transitory computer readable storage medium of claim 8, wherein the method comprises:
after detecting the input corresponding to the request to create the one or more alternative timelines, updating display, via the one or more displays, of the media editor environment to include a timeline coalescing user interface element that coalesces the plurality of timelines at a second time position in the first timeline after the first time position in the first timeline.

12. The non-transitory computer readable storage medium of claim 8, wherein the method comprises:
detecting an input corresponding to a request to add to the first timeline a timeline coalescing user interface element that coalesces the plurality of timelines at a second time position in the first timeline after the first time position in the first timeline; and
in response to detecting the input corresponding to the request to add the timeline coalescing user interface element, adding the timeline coalescing user interface element to the first timeline, including displaying the plurality of timelines coalescing into the timeline coalescing user interface element.

13. The non-transitory computer readable storage medium of claim 8, wherein displaying the media editor environment includes displaying a preview window for previewing content of the first timeline.

14. The non-transitory computer readable storage medium of claim 8, wherein the plurality of timelines includes a default timeline that is created in response to detecting the input corresponding to the request to create the one or more alternative timelines.

15. An electronic device comprising:
one or more processors; and
memory;
wherein the one or more processors are configured to execute one or more programs stored in the memory, the one or more programs including instructions for:
displaying, via one or more displays of the electronic device, a media editor environment in a three-dimensional (3D) environment, the media editor environment including:
a first timeline for arranging content of a media project, the first timeline including one or more user first interface elements configured to receive one or more 3D representations of media content;
while displaying the first timeline including a first 3D representation of first media content, detecting an input corresponding to a request to create one or more alternative timelines, different from the first timeline, at a first time position in the first timeline; and
in response to detecting the input corresponding to the request to create the one or more alternative timelines, adding to the first time position in the first timeline a first timeline branching user interface element for branching the first timeline into a plurality of timelines.

16. The electronic device of claim 15, wherein the plurality of timelines includes a first alternative timeline and a second alternative timeline, different from the first alternative timeline.

17. The electronic device of claim 16, wherein the one or more programs include instructions for:
detecting an input corresponding to a request to add a second 3D representation of second media content, different from the first 3D representation of first media content, to the second alternative timeline; and
in response to detecting the input corresponding to the request to add the second 3D representation of second media content to the second alternative timeline, adding the second 3D representation of second media content to the second alternative timeline; and
after adding the second 3D representation of second media content to the second alternative timeline, updating display, via the one or more displays, of the media editor environment to include:
the first timeline having the first 3D representation of the first media content;
the first alternative timeline; and
the second alternative timeline having the second 3D representation of the second media content.

18. The electronic device of claim 17, wherein:
the media project includes:
the first timeline including the first media content;
a first alternative timeline branching from the first timeline, the first alternative timeline including first alternative media content; and
a second alternative timeline branching from the first timeline, the second alternative timeline including second alternative media content; and
the one or more programs include instructions for:
during a runtime of the media project:
while displaying media content of the first timeline associated with the first time position in the first timeline, detecting a gaze of a user directed to a respective portion of the media content; and
in response to detecting the gaze of the user:
in accordance with a determination that the respective portion of the first media content is a first portion, causing display of the first alternative media content; and
in accordance with a determination that the respective portion of the first media content is a second portion different from the first portion, causing display of the second alternative media content.

19. The electronic device of claim 18, wherein when the gaze of the user is detected, the media project is in a first state of playback, and in response to the detecting the gaze of the user, the media project is in the first state of playback.

20. The electronic device of claim 15, wherein the plurality of timelines includes a first alternative timeline, a second alternative timeline, different from the first alternative timeline, and a third alternative timeline, different from the first alternative timeline and the second alternative timeline.
